(19) United States
(12) Patent Application Publication
(10) Pub. No.: US 2009/0031398 A1
(43) Pub. Date: Jan. 29, 2009

(54) ROLE DETERMINATION FOR MESHED NODE AUTHENTICATION

(75) Inventors: Heyun Zheng, Winter Springs, FL (US); Surong Zeng, Schaumburg, IL (US)

Correspondence Address: MOTOROLA, INC, 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/781,509

(22) Filed: Jul. 23, 2007

(51) Int. Cl. G06F 7/04

(52) U.S. Cl. 726/3

(57) ABSTRACT

Techniques are provided for determining respective roles of a first meshed node (MN) and a second MN during an authentication process. The first MN and the second MN determine whether at least one of the first MN and the second MN have a secure connection to an authentication server. When the first MN and the second MN each have a secure connection to the authentication server, the first MN and the second MN determine whether a first authentication message forwarding cost (AMFC) associated with the first MN is the same as a second AMFC associated with the second MN. When the first AMFC associated with the first MN is the different than the second AMFC associated with the second MN, the MN having the lower AMFC to an IAP (coupled to the authentication server) assumes the authenticator role, and the other MN having the higher AMFC assumes the supplicant role.

### FIELD OF THE INVENTION

The present invention relates generally to authentication of meshed nodes in a multi-hop wireless network, and more particularly to techniques for allowing meshed nodes which implement a hop-by-hop security model to make a supplicant/authenticator role determination.

### BACKGROUND

An “ad hoc network” refers to a self-configuring network of nodes connected by wireless links which form an arbitrary topology. An ad hoc network typically includes a number of geographically-distributed, potentially mobile units, sometimes referred to as “nodes,” which are wirelessly connected to each other by one or more links (e.g., radio frequency communication channels). The nodes can communicate with each other over a wireless media without the support of an infrastructure-based or wired network. Links or connections between these nodes can change dynamically in an arbitrary manner as existing nodes move within the ad hoc network, as new nodes join or enter the ad hoc network, or as existing nodes leave or exit the ad hoc network. One characteristic of the nodes is that each node can directly communicate over a short range with nodes which are a single “hop” away. Such nodes are sometimes referred to as “neighbor nodes.” A large network can be realized using intelligent access points (IAP) which provide wireless nodes with access to a wired backhaul.

A wireless mesh network is a collection of wireless nodes or devices organized in a decentralized manner to provide range extension by allowing nodes to be reached across multiple hops. In a multi-hop network, communication packets sent by a source node can be relayed through one or more intermediary nodes before reaching a destination node. When a node transmits packets to a destination node and the nodes are separated by more than one hop (e.g., the distance between two nodes exceeds the radio transmission range of the nodes, or a physical barrier is present between the nodes), the packets can be relayed via intermediate nodes (“multi-hopping”) until the packets reach the destination node. In such situations, each intermediate node routes the packets (e.g., data and control information) to the next node along the route, until the packets reach their final destination. For relaying packets to the next node, each node maintains routing information collected through communication with neighboring nodes. The routing information can also be periodically broadcast in the network to reflect the current network topology. Alternatively, to reduce the amount of information transmitted for maintaining accurate routing information, the network nodes may exchange routing information only when it is needed. In an approach known as Mesh Scalable Routing (MSR), nodes periodically send HELLO messages (e.g., once per second) that contain routing and metrics information associated with the route to its bound intelligent access point (IAP), and discover certain peer routes on-demand.

Wireless mesh networks can include both routable or “meshed” nodes, and non-routable or “non-meshed” nodes. Meshed or “routable” nodes are devices which may follow a standard wireless protocol such as Institute of Electrical and Electronics Engineers (IEEE) 802.11s or 802.16j. These devices are responsible for forwarding packets to/from the proxy devices which are associated with them. Non-meshed or “non-routable” nodes are devices following a standard wireless protocol such as IEEE 802.11a, b, e, g or IEEE 802.15 but not participating in any kind of routing. These devices are “proxied” by meshed devices which establish routes for them. As used herein, “IEEE 802.11” refers to a set of IEEE Wireless LAN (WLAN) standards that govern wireless networking transmission methods. IEEE 802.11 standards have been and are currently being developed by working group 11 of the IEEE LAN/MAN Standards Committee (IEEE 802). Any of the IEEE standards or specifications referred to herein may be obtained at http://standards.ieee.org/getieee802/index.html or by contacting the IEEE at IEEE, 445 Hoes Lane, PO Box 1331, Piscataway, N.J. 08855-1331, USA.

Mobile nodes such as cellular phones, personal digital assistants (PDAs) and notebook computers often require authentication when accessing remote databases or networks. In prior systems, a centralized authentication procedure is followed where a single Access Point (AP), such as a base station, handles an authentication process for all nodes within range of the AP. For instance, systems which adhere to American National Standards Institute/Institute of Electrical and Electronics Engineers (ANSI/IEEE) 802.1X or ANSI/IEEE 802.11i standards utilize such a centralized procedure to control access to network resources.

IEEE 802.1X is an IEEE standard that was initially designed to provide authentication, access control, and key management in both wired and wireless networks. The IEEE 802.1X standard defines the roles of three entities which are commonly known as a supplicant, an authenticator and an Authentication Server (AS). The supplicant is the node seeking authentication and access authorization. The authenticator is the node with which the supplicant communicates directly. The AS, sometimes referred to as the Authentication, Authorization and Accounting (AAA) Server, authenticates and grants access, if authorized, to a supplicant based on the supplicant's credentials. In some cases, the AS can be co-located with an authenticator. Authentication is conducted between the supplicant and the Authentication Server while the authenticator acts as a pass-through of the authentication messages. The authenticator has an uncontrolled port and a controlled port for every client. Before a client is authenticated, only authentication messages are allowed to pass through the uncontrolled port. Only after the supplicant is successfully authenticated can other traffic be passed via the controlled port.

As described in the “IEEE Standard for Local and metropolitan area networks—Port-Based Network Access Control,” IEEE 802.1X-2001, June 2001, supplicants (or nodes seeking to authenticate and gain access) are assumed to be one hop from the authenticator (e.g., an access point (AP)) which is coupled to the authentication server (AS) over infrastructure connections to grant or refuse access. Traditional 802.1X does not contemplate multi-hop communication between the supplicant and the authentication server. It does not contemplate multi-hop communication between the authenticator and the authentication server either. Because every supplicant can be authenticated only via an AP which is coupled to the authentication server over the infrastructure connections, such a centralized procedure might not be practical in ad hoc wireless communication networks that have nodes outside of the wireless communication range of an AP (e.g., an intelligent access point (IAP)) which has infrastructure connection to the authentication server.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a simplified representation of a multi-hop wireless mesh network; and

FIG. 2 is a flow diagram which illustrates a role determination method according to one embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail various embodiments that are in accordance with the present invention, it should be observed that the embodiments reside primarily in combinations of method steps and apparatus components related to a role determination technique which meshed nodes can use to determine their respective roles during an authentication process. Accordingly, the apparatus components and method steps have been represented where appropriate by conventional symbols in the drawings, showing only those specific details that are pertinent to understanding the embodiments of the present invention, so as not to obscure the disclosure with details that will be readily apparent to those of ordinary skill in the art having the benefit of the description herein.

In this document, relational terms such as first and second and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions for a role determination technique which meshed nodes can use to determine their respective roles during an authentication process, as described herein. The non-processor circuits may include, but are not limited to, a radio receiver, a radio transmitter, signal drivers, clock circuits, power source circuits, and user input devices. As such, these functions may be interpreted as steps of a role determination method which meshed nodes can use to determine their respective roles during an authentication process. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Any embodiment described herein is not necessarily to be construed as preferred or advantageous over other embodiments. All of the embodiments described in this Detailed Description are illustrative provided to enable persons skilled in the art to make or use the invention and not to limit the scope of the invention which is defined by the claims.

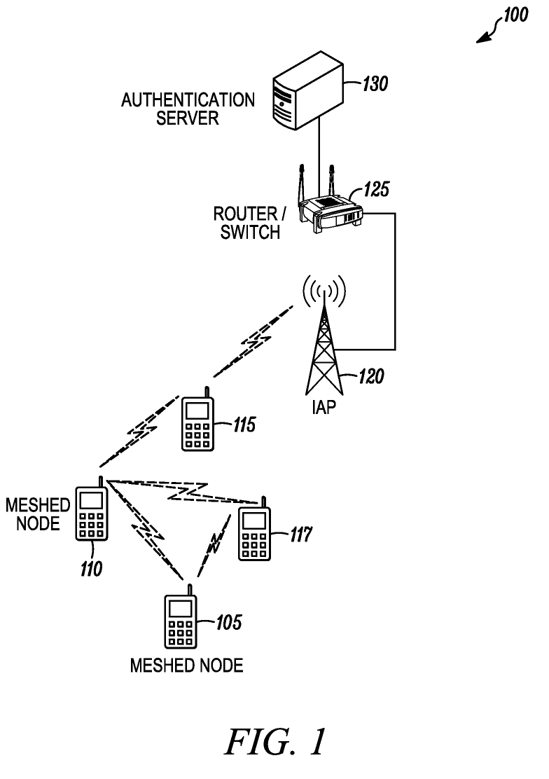

Prior to describing some embodiments of techniques for determining respective roles of a first meshed node (MN) and a second MN during an authentication process, for purposes of convenience, a simplified representation of a multi-hop wireless mesh network and some of the basic background terminology that is repeatedly referenced in the following description will be described with reference to FIG. 1.

FIG. 1 is a simplified representation of a multi-hop wireless mesh network 100. The network 100 comprises a plurality of nodes including meshed nodes 105, 110, 115, 117, at least one intelligent access point (IAP) 120 which provides the access to the wired network/wide area network (WAN) for other meshed nodes, an infrastructure device 125 which can include a router and/or switch, and a central authentication server (AS) 130 which can be, for example, a AAA server 130. The infrastructure portion of the network includes IAP 120 which is coupled to the AAA server 130 via the infrastructure device 125. In this network configuration, meshed node 115 is one hop from the IAP 120, meshed node 110 is two hops from the IAP 120, and meshed nodes 105, 117 are three hops from the IAP 120.

As used herein, the term “meshed node” refers to a communication device which has “meshing capability” meaning that a node has routing functionality and can route traffic to and from other nodes with routing functionality. As used herein the term “routing algorithm” or “routing protocol” refers to a protocol used by a routing module to determine the appropriate path over which data is transmitted. The routing protocol also specifies how nodes in a communication network share information with each other and report changes. The routing protocol enables a network to make dynamic adjustments to its conditions, so routing decisions do not have to be predetermined and static. A routing protocol controls how nodes come to agree which way to route packets between the nodes and other computing devices in a network. Any routing algorithm or protocol can be used in conjunction with the multi-radio system(s) described herein. There are numerous existing ad hoc routing protocols. Examples of some ad hoc routing protocols include, for example, protocols, such as, Ad hoc On-demand Distance Vector (AODV) routing protocol, Dynamic Source Routing (DSR) protocols, and Mesh Scalable Routing (MSR) protocol. A meshed node can implement a mesh routing protocol such as MSR protocol. Examples of meshed nodes include a mesh point (MP), a Mesh Access Point (MAP), and an intelligent Access Point (IAP).

As used herein, the term “Meshed Access Point (MAP)” refers to an AP having meshing capability. A MAP is distinguishable from a regular AP in that an MAP implements a mesh routing protocol such as a Mesh Scalable Routing (MSR) protocol disclosed in U.S. Pat. No. 7,061,925 B2, entitled “System and Method for Decreasing Latency in Locating Routes Between Nodes in a Wireless Communication Network” granted Jun. 13, 2006, its contents being incorporated by reference in its entirety herein. The term “meshed node” is equivalent to MAP. The term “Intelligent Access Point (AP)” refers to a specific type of MAP which connects to a wired network and enables remote wireless nodes to communicate with the wired network (e.g. local area network (LAN), wide area network (WAN), etc.). In some implementations, IAPs and MAPs can enable communication between the wired network and remote wireless nodes which are multiple hops away through the MSR protocol and its proxy routing variant as described in United States Published Patent Application Publication Number 20060098612, filed Sep. 7, 2005, entitled “System and method for associating different types of nodes with access point nodes in a wireless network to route data in the wireless network”, and United States Published Patent Application Publication Number 20060098611, filed Sep. 7, 2005, entitled “System and method for routing data between different types of nodes in a wireless network.” When a meshed node/MAP is authenticated by the authentication server, the connection between the authenticated meshed node/MAP and the authentication server is called as a secure connection, and the authenticated meshed node has a secure connection to the authentication server.

### Overview

In a wireless mesh network which implements a hop-by-hop security model, each meshed node in multi-hop wireless mesh network can utilize an authentication and key management process to establish a unique link security key with each of its neighboring meshed nodes. This key can then be used to protect data traffic transferred over links established between those meshed nodes. Approaches for key establishment are described, for example, in published United States Patent Application Publication Number US-2006-0236377-A1 entitled “System And Methods For Providing Multi-Hop Access In A Communications Network,” by inventors Anthony Metke et al., filed on Apr. 19, 2005 (and published on Oct. 19, 2006), and U.S. patent application Ser. No. 11/464744 entitled “Ad-Hoc Network Key Management,” by inventors Zhi Fu et al., filed on Aug. 15, 2006, the entire contents of each being incorporated herein by reference.

However, before neighboring meshed nodes can establish their unique link security key, it is first necessary for those meshed nodes to determine their respective supplicant and authenticator roles in the context of the IEEE 802.1X framework. One of the two meshed nodes will assume the authenticator role and the other will assume the supplicant role. To determine which meshed node assumes which role, a current approach for role determination involves the meshed nodes checking to see if only one of the meshed nodes has the secure connection to the AS. If so, then that meshed node assumes the authenticator role, and the other meshed node assumes the supplicant role. However, if both meshed nodes have the secure connection to the AS, then the meshed node which has a higher MAC address assumes the authenticator role, and the other meshed node assumes the supplicant role.

Although the conventional role determination approach described above works in distributed authentication scenarios, such as in the IEEE 802.11i Independent Basic Service Set (IBSS) mode, this approach has its shortcomings. For example, when two meshed nodes are preparing to authenticate and try to determine their respective roles, the meshed node which assumes the authenticator role may actually have a larger authentication message forwarding cost (AMFC) associated with forwarding authentication messages to a central authentication server (AS) which is multiple hops or wireless links away. In some scenarios, an IAP may assume the supplicant role with respect to other wireless meshed nodes which assume the authenticator role. This is undesirable in terms of optimized network performance.

The disclosed embodiments relate to an authentication role determination protocol for use by meshed nodes in a multi-hop authentication framework. This authentication role determination protocol can be implemented, for example, in an infrastructure-based multi-hop wireless network which implements a hop-by-hop security model including IEEE 802.1X compliant networks. To support the role determination protocol, each meshed node regularly transmits or “advertises” an authentication message forwarding cost (AMFC) parameter. The AMFC parameter measures the routing cost from a meshed node to an IAP coupled to a central authentication server (AS). The cost is measured only from the meshed node to the IAP or “along the wireless portion of the authentication message communication path.” Various metrics can be used to calculate the AMFC parameter. In its simplest form, the AMFC can be the wireless hop count from the meshed node to the IAP.

According to one embodiment of the role determination protocol, if only one meshed node has the secure connection to the AS, this meshed node assumes the authenticator role and the other meshed node assumes the supplicant role. If both meshed nodes have the secure connection to the AS, the meshed node which has lower authentication message forwarding cost assumes the authenticator role and the other meshed node shall the supplicant role. If both meshed nodes have the secure connection to the AS and also the authentication message forwarding cost for the both meshed node are equal, then, the meshed node which has a higher (or lower) MAC address assume the authenticator role and the other meshed node which has a lower (or higher) MAC address the supplicant role.

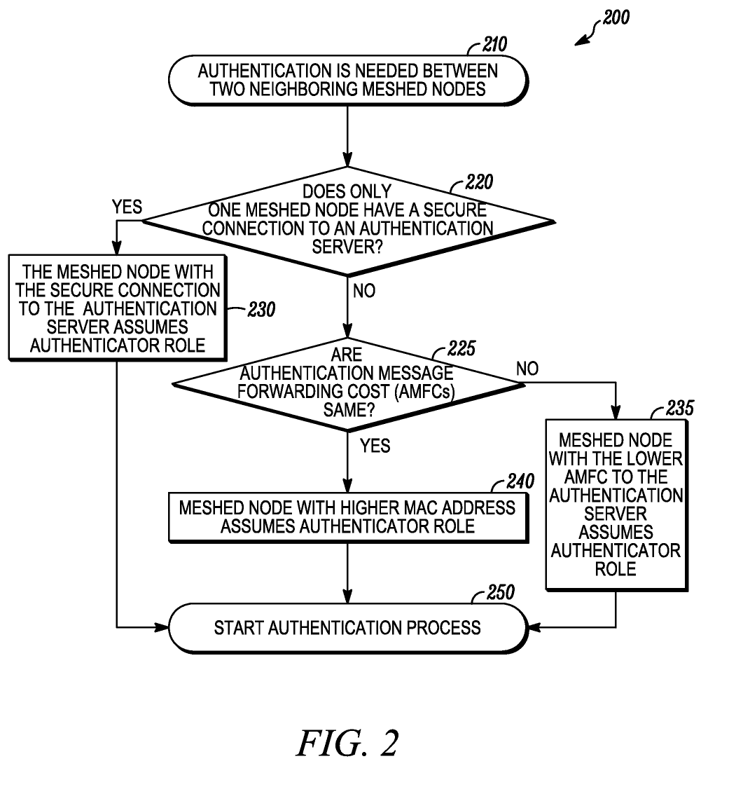

FIG. 2 is a flow diagram which illustrates a role determination method 200 according to one embodiment of the present invention. In the following example, meshed nodes 105 and 110 use the role determination method 200 to determine their respective roles, for example, during an IEEE 802.1X authentication process. To support the role determination method 200 each of the meshed nodes 105, 110 can regularly calculate an “authentication message forwarding cost,” and transmit the authentication message forwarding cost in an advertisement message comprising an authentication message forwarding cost field or information element. The advertisement message can generally be regarded as an information element or field that can be included as part of another message. The advertisement message can be implemented using any regularly transmitted message, and can be implemented using, for example, a HELLO message, a beacon frame, a routing advertisement message, a neighbor advertisement message or a link state advertisement message.

The authentication message forwarding or routing cost can be calculated based on route quality information including one or more indicia of route quality or metrics including, but not limited to, a number of hops along a particular route between the meshed node 105, 110 and an intelligent access point 120 coupled to the authentication server 130, data rates of each link/hop along the particular route between the meshed node 105, 110 and an intelligent access point 120 coupled to the authentication server 130, packet completion rates of each link/hop along the particular route between the meshed node 105, 110 and an intelligent access point 120 coupled to the authentication server 130, link quality of each link/hop along the particular route between the meshed node 105, 110 and an intelligent access point 120 coupled to the authentication server 130, MAC overhead of each link/hop along the particular route between the meshed node 105, 110 and an intelligent access point 120 coupled to the authentication server 130, throughput along the particular route between the meshed node 105, 110 and an intelligent access point 120 coupled to the authentication server 130, queue length of each link/hop along the particular route between the meshed node 105, 110 and an intelligent access point 120 coupled to the authentication server 130, queuing delay of each link/hop along the particular route between the meshed node 105, 110 and an intelligent access point 120 coupled to the authentication server 130, battery power lever of nodes located along the particular route between the meshed node 105, 110 and an intelligent access point 120 coupled to the authentication server 130, and device types of nodes along the particular route between the meshed node 105, 110 and an intelligent access point 120 coupled to the authentication server 130. Some examples of route quality metrics are described, for example, in United States Patent Application Publication Number 20020191573, entitled “Embedded Routing Algorithms Under the Internet Protocol Routing Layer of a Software Architecture Protocol Stack in a Mobile Ad-Hoc Network”; United States Patent Application Publication No. 20040246935, entitled “System and Method for Characterizing the Quality of a Link in a Wireless Network,” by inventors Avinash Joshi et al., published Dec. 9, 2004; United States Patent Application Publication Number 20040252643-A1, entitled “System and Method to Improve the Network Performance of a Wireless Communication Network by Finding an Optimal Route Between a Source and a Destination,” by inventor Avinash Joshi, published on Dec. 16, 2004; United States Patent Application Publication Number 20040143842-A1, entitled “System and Method for Achieving Continuous Connectivity to an Access Point or Gateway in a Wireless Network Following an On-Demand Routing Protocol, and to Perform Smooth Handoff of Mobile Terminals Between Fixed Terminals in the Network,” by inventor Avinash Joshi, published on Jul. 22, 2004; and United States Patent Application Publication No. 20040260808, entitled “A System and Method for Providing a Measure of Link Reliability to a Routing Protocol in an Ad Hoc Wireless Network,” by inventor Gucnacl T. Strutt, published Dec. 23, 2004, the entire contents of each being incorporated herein by reference.

The method 200 is initiated at step 210 when two neighboring meshed nodes 105, 110 begin an authentication process such as an IEEE 802.1X authentication process, etc. At step 220, the meshed nodes 105, 110 determine whether at least one of the meshed node 110 and the meshed node 105 have a secure connection to an authentication server 130.

When only one of the meshed nodes 105, 110 has a secure connection to the authentication server 130 and the other does not (e.g., when the meshed node 110 has a secure connection to the authentication server 130 and the meshed node 105 does not have a secure connection to the authentication server 130 or vice-versa), then the meshed node which has a secure connection to the authentication server 130 assumes an authenticator role and the other meshed node assumes a supplicant role as illustrated at step 230. Although not illustrated in FIG. 2, it should be noted that when neither the meshed node 110 nor the meshed node 105 have a secure connection to the authentication server 130 (i.e., neither meshed point has a secure connection to the IAP/authentication server), then both of them should look for other meshed node which have a secure connection to initiate the role determination process, and they can not authenticate each other directly.

However, when the meshed nodes 105, 110 each have a secure connection to the authentication server 130, the method proceeds to step 225, where the meshed nodes 105, 110 determine whether a first authentication message forwarding cost associated with the meshed node 110 is the same as a second authentication message forwarding cost associated with the meshed node 105.

If the first authentication message forwarding cost associated with the meshed node 110 is different than the second authentication message forwarding cost associated with the meshed node 105, then the method 200 proceeds to step 235, where the meshed node 105, 110 which has the lower authentication message forwarding cost (to the IAP 120 coupled to the authentication server 130) assumes the authenticator role, and the other meshed node having the higher authentication message forwarding cost (to the IAP 120 coupled to the authentication server 130) assumes the supplicant role.

If the first authentication message forwarding cost associated with the meshed node 110 is the same as the second authentication message forwarding cost associated with the meshed node 105, then the method 200 proceeds to step 240, where the meshed node 105, 110 which has the higher medium access control (MAC) address assumes the authenticator role, and the other meshed node having the lower MAC address assumes the supplicant role. In other implementations (not illustrated in FIG. 2), the meshed node 105, 110 which has the lower medium access control (MAC) address assumes the authenticator role, and the other meshed node having the higher MAC address assumes the supplicant role.

Once the meshed nodes 105, 110 have assumed their respective authentication roles at step 230, 235 or 240, the method 200 proceeds to step 250, where the meshed nodes 105, 110 begin an authentication process.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as critical, required, or essential features or elements of any or all the claims. The invention is defined solely by the appended claims including any amendments made during the pendency of this application and all equivalents of those claims as issued.

We claim:

1. A method for determining respective roles of a first meshed node and a second meshed node during an authentication process, the method comprising:
assuming an authenticator role at the one of the first meshed node and the second meshed node having a lower authentication message forwarding cost to an IAP coupled to an authentication server; and
assuming a supplicant role at the one of the first meshed node and the second meshed node having a higher authentication message forwarding cost to the IAP coupled to the authentication server.

2. A method according to claim 1, further comprising:
determining, at the first meshed node and the second meshed node, whether a first authentication message forwarding cost associated with the first meshed node is the same as a second authentication message forwarding cost associated with the second meshed node when the first meshed node and the second meshed node each have a secure connection to the authentication server, and wherein the step of assuming a supplicant role comprises:
assuming a supplicant role at the one of the first meshed node and the second meshed node having a higher authentication message forwarding cost to the IAP coupled to the authentication server when the first authentication message forwarding cost associated with the first meshed node is different than the second authentication message forwarding cost associated with the second meshed node.

3. A method according to claim 1, further comprising:
transmitting, from the first meshed node and the second meshed node, an advertisement message comprising authentication message forwarding cost information.

4. A method according to claim 1, further comprising:
determining, at the first meshed node and the second meshed node, whether at least one of the first meshed node and the second meshed node have a secure connection to an authentication server via an Intelligent Access Point (IAP); and
assuming an authenticator role at the first meshed node and a supplicant role at the second meshed node when the first meshed node has a secure connection to the authentication server and the second meshed node does not have a secure connection to the authentication server.

5. A method according to claim 1, further comprising:
assuming the authenticator role at the one of the first meshed node and the second meshed node having a higher medium access control (MAC) address and assuming the supplicant role at the one of the first meshed node and the second meshed node having a lower medium access control (MAC) address when the first authentication message forwarding cost associated with the first meshed node is the same as the second authentication message forwarding cost associated with the second meshed node.

6. A method according to claim 1, further comprising:
assuming the authenticator role at the one of the first meshed node and the second meshed node having a lower medium access control (MAC) address and assuming the supplicant role at the one of the first meshed node and the second meshed node having a higher medium access control (MAC) address when the first authentication message forwarding cost associated with the first meshed node is the same as the second authentication message forwarding cost associated with the second meshed node.

7. A method according to claim 1, further comprising:
starting an authentication process at the first meshed node and the second meshed node when the first meshed node and the second meshed node have assumed their respective authentication roles.

8. A method according to claim 3, wherein the authentication message forwarding cost information is calculated based on route quality information including at least one of:
a number of hops along a particular route between the meshed node and an intelligent access point coupled to the authentication server;
data rates of each link/hop along the particular route between the meshed node and an intelligent access point coupled to the authentication server;
packet completion rates of each link/hop along the particular route between the meshed node and an intelligent access point coupled to the authentication server;
link quality of each link/hop along the particular route between the meshed node and an intelligent access point coupled to the authentication server;
MAC overhead of each link/hop along the particular route between the meshed node and an intelligent access point coupled to the authentication server;
throughput along the particular route between the meshed node and an intelligent access point coupled to the authentication server;
queue length of each link/hop along the particular route between the meshed node and an intelligent access point coupled to the authentication server;
queuing delay of each link/hop along the particular route between the meshed node and an intelligent access point coupled to the authentication server;
battery power lever of nodes located along the particular route between the meshed node and an intelligent access point coupled to the authentication server;
processing load on the authentication server coupled with the intelligent access point; and
device types of nodes along the particular route between the meshed node and an intelligent access point coupled to the authentication server.

9. A method according to claim 3, wherein the advertisement message comprises one of:
a HELLO message;
a beacon message;
a neighbor advertisement message;
a routing advertisement message; and
a link advertisement message.

10. A method according to claim 1, wherein meshed node having the lower authentication message forwarding cost has a better quality route to the IAP than the meshed node having the higher authentication message forwarding cost.

11. An ad-hoc network comprising:
an authentication server;
an Intelligent Access Point (IAP) coupled to the authentication server;
a first meshed node designed to regularly transmit an advertisement message comprising first authentication message forwarding cost information; and
a second meshed node designed to regularly transmit an advertisement message comprising second authentication message forwarding cost information,
wherein the first meshed node and the second meshed node are designed to:
determine whether a first authentication message forwarding cost associated with the first meshed node is the same as a second authentication message forwarding cost associated with the second meshed node to determine respective roles the first meshed node and the second meshed node during an authentication process.

12. An ad-hoc network according to claim 11, wherein the first meshed node and the second meshed node are designed to:
determine whether at least one of the first meshed node and the second meshed node have a secure connection to the authentication server via the Intelligent Access Point (IAP), and
wherein the first meshed node and the second meshed node are designed to whether the first authentication message forwarding cost associated with the first meshed node is the same as the second authentication message forwarding cost associated with the second meshed node to determine respective roles the first meshed node and the second meshed node during an authentication process, when the first meshed node and the second meshed node each have a secure connection to the authentication server.

13. An ad-hoc network according to claim 11, when the first authentication message forwarding cost associated with the first meshed node is different than the second authentication message forwarding cost associated with the second meshed node, wherein the one of the first meshed node and the second meshed node having a lower authentication message forwarding cost to an IAP coupled to the authentication server assumes the authenticator role and wherein the one of the first meshed node and the second meshed node having a higher authentication message forwarding cost to the IAP coupled to the authentication server assumes the supplicant role.

14. An ad-hoc network according to claim 13, wherein the meshed node having the lower authentication message forwarding cost has a better quality route to the IAP than the meshed node having the higher authentication message forwarding cost.

15. An ad-hoc network according to claim 11, when the first meshed node has a secure connection to the authentication server and the second meshed node does not have a secure connection to the authentication server, wherein the first meshed node assumes an authenticator role and wherein the second meshed node assumes a supplicant role.

16. An ad-hoc network according to claim 11, when the first authentication message forwarding cost associated with the first meshed node is the same as the second authentication message forwarding cost associated with the second meshed node, wherein the one of the first meshed node and the second meshed node having a higher medium access control (MAC) address assume the authenticator role and wherein the one of the first meshed node and the second meshed node having a lower medium access control (MAC) address assumes the supplicant role.

17. An ad-hoc network according to claim 11, when the first authentication message forwarding cost associated with the first meshed node is the same as the second authentication message forwarding cost associated with the second meshed node, wherein the one of the first meshed node and the second meshed node having a lower medium access control (MAC) address assume the authenticator role and wherein the one of the first meshed node and the second meshed node having a higher medium access control (MAC) address assumes the supplicant role.

18. An ad-hoc network according to claim 11, wherein the authentication message forwarding cost information is calculated based on route quality information including at least one of:
a number of hops along a particular route between the meshed node and an intelligent access point coupled to the authentication server;
data rates of each link/hop along the particular route between the meshed node and an intelligent access point coupled to the authentication server;
packet completion rates of each link/hop along the particular route between the meshed node and an intelligent access point coupled to the authentication server;
link quality of each link/hop along the particular route between the meshed node and an intelligent access point coupled to the authentication server;
MAC overhead of each link/hop along the particular route between the meshed node and an intelligent access point coupled to the authentication server;
throughput along the particular route between the meshed node and an intelligent access point coupled to the authentication server;
queue length of each link/hop along the particular route between the meshed node and an intelligent access point coupled to the authentication server;
queuing delay of each link/hop along the particular route between the meshed node and an intelligent access point coupled to the authentication server;
battery power lever of nodes located along the particular route between the meshed node and an intelligent access point coupled to the authentication server;
processing load on the authentication server coupled with the intelligent access point; and
device types of nodes along the particular route between the meshed node and an intelligent access point coupled to the authentication server.

19. An ad-hoc network according to claim 11, wherein the advertisement message comprises one of:
a HELLO message;
a beacon message;
a neighbor advertisement message;
a routing advertisement message; and
a link advertisement message.

20. A first meshed node, comprising:
a transmitter designed to regularly transmit an advertisement message comprising first authentication message forwarding cost information; and
a receiver designed to receive another advertisement message comprising second authentication message forwarding cost information from a second meshed node; and
a processor designed to: determine whether a first authentication message forwarding cost associated with the first meshed node is the same as a second authentication message forwarding cost associated with the second meshed node to determine respective roles the first meshed node and the second meshed node during an authentication process.

21. A first meshed node according to claim 20, wherein the processor is further designed to:
determine whether at least one of the first meshed node and the second meshed node have a secure connection to an authentication server via an Intelligent Access Point (IAP); and
determine, when the first meshed node and the second meshed node each have a secure connection to the authentication server, whether a first authentication message forwarding cost associated with the first meshed node is the same as a second authentication message forwarding cost associated with the second meshed node to determine respective roles the first meshed node and the second meshed node during an authentication process.

22. A first meshed node according to claim 20, when the processor determines that the first authentication message forwarding cost associated with the first meshed node is different than the second authentication message forwarding cost associated with the second meshed node, wherein the processor is further designed to:
determine which one of the first meshed node and the second meshed node has a lower authentication message forwarding cost to an IAP coupled to the authentication server, wherein the meshed node having the lower authentication message forwarding cost has a better quality route to the IAP than the meshed node having a higher authentication message forwarding cost to the IAP coupled to the authentication server; and
designate the one of the first meshed node and the second meshed node having the lower authentication message forwarding cost as having the authenticator role, and designate the one of the first meshed node and the second meshed node having the higher authentication message forwarding cost as having the supplicant role.

23. A first meshed node according to claim 21, when the first meshed node has a secure connection to the authentication server and the second meshed node does not have a secure connection to the authentication server, wherein the processor is designed to:
designate the first meshed node as having the authenticator role, and designate the second meshed node as having the supplicant role.

24. A first meshed node according to claim 20, when the processor determines that the first authentication message forwarding cost associated with the first meshed node is the same as the second authentication message forwarding cost associated with the second meshed node, wherein the processor is further designed to:
determine which one of the first meshed node and the second meshed node has a higher medium access control (MAC) address.

25. A first meshed node according to claim 24, wherein the processor is further designed to:
designate the one of the first meshed node and the second meshed node having a lower medium access control (MAC) address as having the supplicant role, and designate the one of the first meshed node and the second meshed node having a higher medium access control (MAC) address as having the authenticator role.

26. A first meshed node according to claim 24, wherein the processor is further designed to:
designate the one of the first meshed node and the second meshed node having a lower medium access control (MAC) address as having the authenticator role, and designate the one of the first meshed node and the second meshed node having a higher medium access control (MAC) address as having the supplicant role.

27. A first meshed node according to claim 20, wherein the processor is further designed to calculate the first authentication message forwarding cost information based on route quality information including at least one of:
a number of hops along a particular route between the meshed node and an intelligent access point coupled to the authentication server;
data rates of each link/hop along the particular route between the meshed node and an intelligent access point coupled to the authentication server;
packet completion rates of each link/hop along the particular route between the meshed node and an intelligent access point coupled to the authentication server;
link quality of each link/hop along the particular route between the meshed node and an intelligent access point coupled to the authentication server;
MAC overhead of each link/hop along the particular route between the meshed node and an intelligent access point coupled to the authentication server;
throughput along the particular route between the meshed node and an intelligent access point coupled to the authentication server;
queue length of each link/hop along the particular route between the meshed node and an intelligent access point coupled to the authentication server;
queuing delay of each link/hop along the particular route between the meshed node and an intelligent access point coupled to the authentication server;
battery power lever of nodes located along the particular route between the meshed node and an intelligent access point coupled to the authentication server;
processing load on the authentication server coupled with the intelligent access point; and
device types of nodes along the particular route between the meshed node and an access point coupled to the authentication server.

28. A first meshed node according to claim 20, wherein the advertisement message comprises one of:
a HELLO message;
a beacon message;
a neighbor advertisement message;
a routing advertisement message; and
a link advertisement message.
